(19) United States
(12) Patent Application Publication
(10) Pub. No.: US 2024/0182272 A1
(43) Pub. Date: Jun. 6, 2024

(54) HOISTING APPARATUS WITH AUTOMATED LOAD LEVELING

(71) Applicant: Shawn Albert Carter, Beaverlodge (CA)

(72) Inventor: Shawn Albert Carter, Beaverlodge (CA)

(21) Appl. No.: 18/062,120

(22) Filed: Dec. 6, 2022

(51) Int. Cl. B66C 13/04; B66C 3/12

(52) U.S. Cl. CPC B66C 13/04; B66C 3/125; B66C 2700/0364

(57) ABSTRACT

A hoisting apparatus that is operable to lift objects from a transport vehicle and further provide positioning thereof in alternate location wherein the present invention provides load leveling and balancing of the object while suspended. The present invention includes a housing that is suspendedly mounted to a crane lifting block. The housing includes an exterior wall having a top and a bottom and further including an interior volume with an opening at the bottom substantially the diameter of the housing. The housing has mounted therein four winches wherein each of the four winches is independently operated so as to separately control the length thereof. A center attachment member is present that is configured to secure the hoisting apparatus to the lifting block of a crane. Securing members are operably coupled to the center attachment member and are equidistantly distributed around the circumference of the housing.

### FIELD OF THE INVENTION

The present invention relates generally to heavy equipment, more specifically but not by way of limitation, a hoisting apparatus that is configured to provide lifting of items such as but not limited to large pipe wherein the present provides leveling control of large loads during the lifting process.

### BACKGROUND

Various industries utilize heavy equipment in order to perform routine tasks that are encountered on a daily basis. Heavy equipment varies according to the required task and can includes equipment such as but not limited to forklifts and cranes. For the latter, there are many industries that utilize cranes to lift items into place during construction or the cranes are further utilized to unload items from transport vehicles such as but not limited to trucks and train cars. Cranes can vary in size with some being large independent equipment like those utilized to build skyscrapers and others that are mounted to specialized heavy trucks. The latter is often employed at construction sites and is utilized both to offload large items from delivery vehicles as well as position the item where needed during construction.

One issue with the existing technology is the ability to easily maintain the level of the load being hoisted by the crane. Typically, a crane will deploy a lifting block wherein the lifting block is controlled by the crane and the lifting block includes straps extending downward therefrom that can be secured to the load in various places. An operator will secure the straps to an area of a load that is believed to represent the best area so as to maintain the balance and level of the load as the load or item is being lifted. While this approach is functional for some routine items there are many items that have an unbalanced weight distribution and these loads can often become unbalanced and as a result either break free of the straps secured from the lifting block or create other issues that present a dangerous scenario.

Accordingly, there is a need for a hoisting apparatus that can be secured to a crane wherein the hoisting apparatus is configured to provide remote load leveling and balancing of an item during the lifting process.

### SUMMARY OF THE INVENTION

It is the object of the present invention to provide a hoisting apparatus that is configured be operably coupled to a crane wherein the present invention is operable to provide remote load leveling and balancing of an item being hoisted by the crane.

Another object of the present invention is to provide a hoisting apparatus operable to remotely balance a load being lifted by a crane to which the hoisting apparatus is secured wherein the present invention includes a housing configured to be operably coupled to a crane.

A further object of the present invention is to provide a hoisting apparatus that is configured be operably coupled to a crane wherein the present invention wherein the housing has operably coupled thereto a center attachment member.

Yet a further object of the present invention is to provide a hoisting apparatus operable to remotely balance a load being lifted by a crane to which the hoisting apparatus is secured wherein the housing has operably coupled thereto four securing members.

Still another object of the present invention is to provide a hoisting apparatus that is configured be operably coupled to a crane wherein the housing is shaped to create an interior volume with an open bottom.

An additional object of the present invention is to provide a hoisting apparatus operable to remotely balance a load being lifted by a crane to which the hoisting apparatus is secured wherein the present invention includes four winches.

Yet a further object of the present invention is to provide a hoisting apparatus that is configured be operably coupled to a crane wherein each of the four winches are arranged at ninety degrees with respect to each other.

Yet another object of the present invention is to provide a hoisting apparatus operable to remotely balance a load being lifted by a crane to which the hoisting apparatus is secured wherein the winches are configured to be remotely and independently operated.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention operably coupled to a crane; and

FIG. 2 is a bottom view of the present invention; and

FIG. 3 is a side view of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a hoisting apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

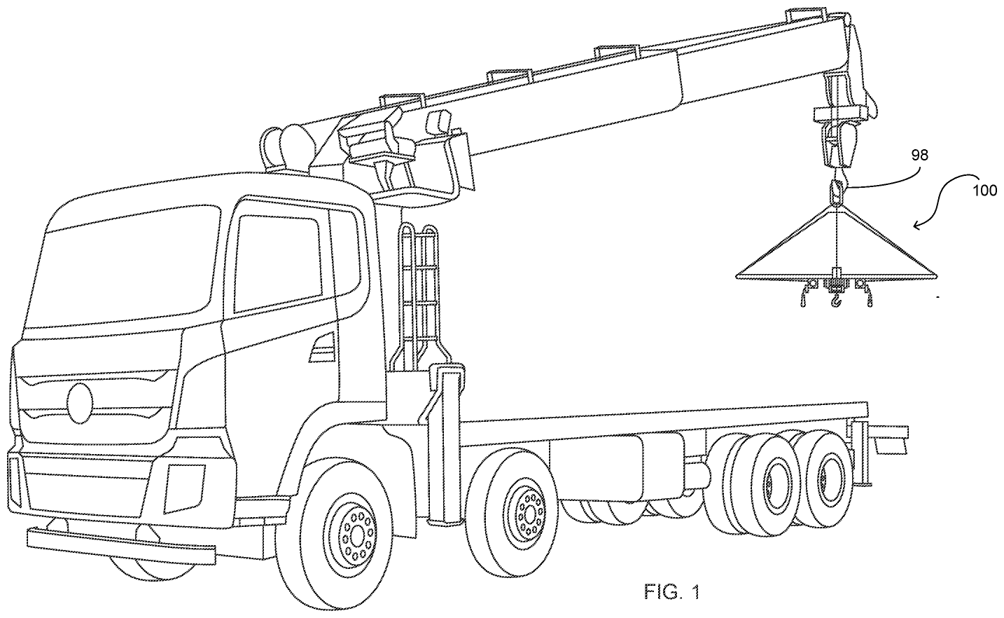

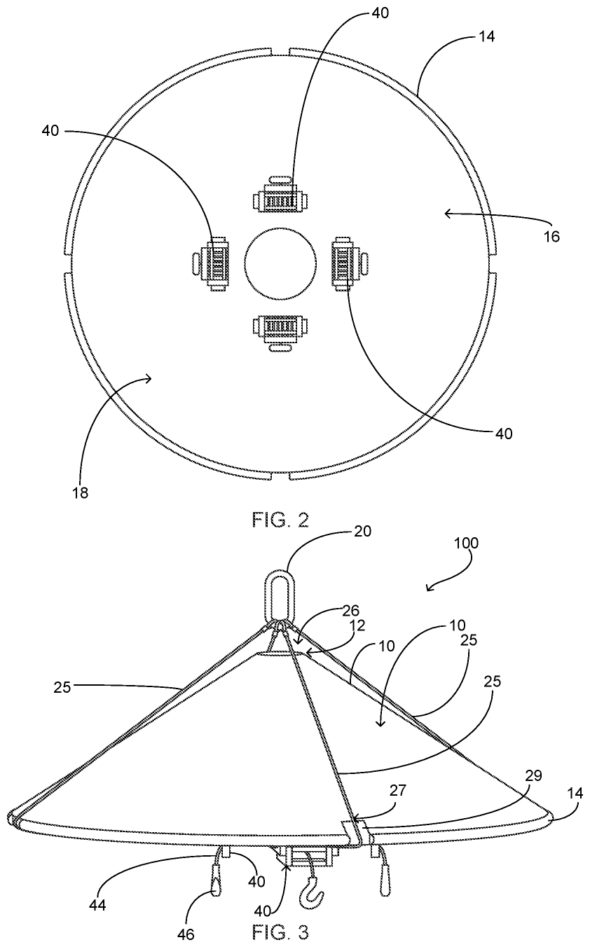

Referring in particular to the Figures submitted herewith, the hoisting apparatus 100 is configured to be operably coupled to an exemplary crane 99 as is illustrated herein in FIG. 1. While a specific type of exemplary crane 99 has been illustrated herein, it should be understood within the scope of the present invention that the hoisting apparatus 100 could be operably coupled to numerous different types of cranes. The hoisting apparatus 100 includes a housing 10 wherein the housing 10 includes an exterior wall 11 forming the shape thereof. The housing 10 is manufactured from a suitable durable material such as but not limited to metal. The housing 10 includes a top 12 and a bottom perimeter edge 14 wherein the bottom perimeter edge 14 defines the opening 16 to the interior volume 18 of the housing 10. In a preferred embodiment the housing 10 is cone shaped as is illustrated herein but it should be understood within the scope of the present invention that the housing 10 could be provided in alternate shapes. The housing 10 is configured with the interior volume 18 so as to provide weather protection for the winches 40 mounted within the interior volume 18 of the housing. Alternate shapes of the housing 10 having an opening at the bottom thereof could be utilized to achieve the desired functionality of providing a protective covering for the winches 40.

The housing 10 includes a center attachment member 20 operably positioned above the top 12 of the housing 10. The center attachment member 20 is located directly above the top 12 and is constructed to operably couple with the hook 98 of the crane 99. The center attachment member 20 is an oval metal ring in a preferred embodiment but it is contemplated within the scope of the present invention that the center attachment member 20 could be constructed in numerous alternate manners in order to achieve the desired objective of operably coupling with the hook 98. Operably coupled to the center attachment member 20 are four securing members 25. The four securing members 25 include upper end 26 secured to center attachment member 20 and a lower end 27 wherein the lower end 27 is operably coupled to the housing 10 with clamp member 29. The four securing members 25 are arranged in a manner such that approximately ninety degrees is present between each securing member 25 providing a balanced loading of the connection between the housing 10 and the center attachment member 20. While a configuration has been illustrated herein for the center attachment member 20, housing 10 and securing members 25, it should be understood within the scope of the present invention that the hoisting apparatus 100 could have alternate configurations and achieve the desired objectives discussed herein. By way of example but not limitation, the housing 10 could be mounted underneath the center attachment member 20 having no load stress placed thereon in an absence of the four securing members 25. The center attachment member 20 could be directly coupled to an element providing mounting support for the four winches 40.

The hoisting apparatus 100 includes four winches 40 mounted within the interior volume 18 of the housing 10. The winches 40 are conventional cable winches having hooks 41 that are configured to be operably coupled to desired locations on an item to be lifted by the hoisting apparatus 100. The winches 40 are electrically operated by a conventional power supply(not illustrated herein). The winches 40 are mounted within the interior volume 18 utilizing suitable durable techniques. The winches 40 are mounted in an arrangement such that there is ninety degrees between each winch 40. This arrangement is configured to provide initial load balancing of the item with which the hoisting apparatus 100 is being utilized to lift. The winches 40 have independent conventional electric power sources and are configured to be independently controlled.

The winches 40 include conventional cable 44 and connection members 46 that are deployed to be operably coupled to an object that needs to be lifted by the hoisting apparatus 100. It should be understood within the scope of the present invention that the connection members 46 could be various elements such as but not limited to hooks. The winches 40 independently deploy the cable 44 to a location on the object to be lifted. As the hoisting apparatus 100 begins to lift the object, the operator of the hoisting apparatus 100 can independently adjust the length of the cable 44 of each which so as to ensure balancing and leveling of the object during the liftin process. While not particularly illustrated herein, it is contemplated within the scope of the present invention that the winches 40 are operably controlled with either a remote control unit or a controlled disposed in the cab of the crane 99. It should be further understood within the scope of the present invention that the winches 40 could be provided with various weight limit ratings such as but not limited to thirteen thousand pounds. The winches 40 are mounted proximate the center of the housing 10 so as to provide a more optimum center of gravity during the lifting process.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A hoisting apparatus configured to be operably coupled to a crane lifting block wherein the hoisting apparatus comprises:
a housing, said housing having a top end and a bottom end, said housing having an exterior wall, said housing having an interior volume, said housing having an opening at said bottom end thereof;
a center attachment member, said center attachment member being proximate said top end of said housing, said center attachment member being configured to operably couple to the crane lifting block;
four winches, said four winches being mounted within the interior volume of said housing, said four winches being mounted in a pattern so as to be equidistant from each other, said four winches having cables and a connection member on ends of the cables, said four winches being independently operable; and
wherein the four winches are configured to independently adjust a length of the cables in order to maintain a level balance of an object being lifted by the hoisting apparatus.

2. The hoisting apparatus configured to be operably coupled to a crane lifting block as recited in claim 1, and further including four securing members, said four securing members having an upper end and a lower end, said upper end of said four securing members being coupled to said center attachment member.

3. The hoisting apparatus configured to be operably coupled to a crane lifting block as recited in claim 2, wherein said housing further includes a bottom perimeter edge, said bottom perimeter edge defining a size of the opening proximate the bottom end of the housing.

4. The hoisting apparatus configured to be operably coupled to a crane lifting block as recited in claim 3, wherein said lower end of said four securing members are operably coupled to the housing proximate the bottom perimeter edge thereof utilizing clamp members.

5. The hoisting apparatus configured to be operably coupled to a crane lifting block as recited in claim 4, wherein the housing is cone shaped.

6. The hoisting apparatus configured to be operably coupled to a crane lifting block as recited in claim 5, wherein said top end of said housing further includes an aperture formed centrally therein.

7. The hoisting apparatus configured to be operably coupled to a crane lifting block as recited in claim 6, wherein the four winches are mounted in a pattern that places each of the four winches ninety degrees apart from each other.

8. The hoisting apparatus configured to be operably coupled to a crane lifting block as recited in claim 7, wherein the four winches are mounted proximate a center of the housing.
